(19) United States
(12) Patent Application Publication
(10) Pub. No.: US 2006/0280492 A1
(43) Pub. Date: Dec. 14, 2006

(54) Auto-focusing device for lens

(75) Inventors: Chi Lone Chang, Jhudong Township (TW); Mao Zen Hsu, Sinfong Township (TW)

Correspondence Address: TROXELL LAW OFFICE PLLC, SUITE 1404, 5205 LEESBURG PIKE, FALLS CHURCH, VA, 22041, US

(73) Assignee: PowerGate Optical Inc.

(21) Appl. No.: 11/197,445

(22) Filed: Aug. 5, 2005

(30) Foreign Application Priority Data
May 27, 2005 (TW) 094117393

(51) Int. Cl. G03B 3/10

(52) U.S. Cl. 396/133

(57) ABSTRACT

An auto-focusing device for lens comprises a lens holder, a sensor holder, a permanent magnet set, a yoke and a base. The lens holder holds a lens barrel and is wound around with at least two coils wound in opposite directions. The sensor holder holds an image sensor. The permanent magnet set includes at least two permanent magnets stacked together with opposing poles to form a multi-pole permanent magnet set. The permanent magnet set is furnished on the periphery of lens holder and corresponding to the two coils. The permanent magnet set is disposed on the yoke to form a close-loop magnetism so as to increase the density of magnetic lines and the efficiency of magnetic force, save power consumption, and extend the service life of device.

### BACKGROUND OF INVENTION

1. Field of the Invention

The present invention relates to an auto-focusing device for lens, more particularly a device used in camera which magnetically drives the lens to shift position and focus automatically by disposing at least two drive coils and having the two adjacent coils wound in opposite directions, and disposing at least two permanent magnets stacked together with opposing poles which correspond to the two coils.

2. Description of the Prior Art

A standard camera 1 comprises a lens set 11, a sensor 12 and a focusing mechanism (not shown in the figure). The lens set 11 forms an image on sensor 12 by refracting the light rays from an object (as shown in FIG. 1). If the distance between lens set 11 and sensor 12 (back focal length, BFL) is fixed, the lens can only show clearly objects at its hyperfocal distance (e.g. 2-3 meters away). For the camera to shoot objects clearly at varying distances (for example at a close distance), the distance between lens set and sensor must be adjusted using a focusing mechanism.

The focusing mechanism 2 used in conventional camera (as shown in FIG. 2) typically comprises an expensive precision drive element 21 (e.g. stepping motor, ultrasonic motor, and piezoelectric actuator) to supply the power needed to drive the lens holder 22 that carries the lens set 11 and a large number of driving elements. Such design has the deficiencies of complicated mechanical configuration, time-consuming assembly, bulkiness and high cost. Most seriously, it consumes a large amount of power. As technology advances, camera makers have been gearing their efforts towards developing high picture quality and small-sized products for easy carriage. Other electronic device makers also focus on integrating more functions in one device by, for example, combining the functions of photographing and mobile communication of handset, the functions of photographing and personal digital assistant (PDA), or the functions of photographing and notebook computer to give the device more powerful video functions. Based on the design of a common power supply having the same capacity as that for a device with single function, how to reduce the size and the cost of product, how to lower power consumption to effectively improve the standby time and run time of the integrated product become the focus of research for electronic product manufacturers.

### SUMMARY OF INVENTION

The primary object of the present invention is to provide an auto-focusing device for lens, which is able to increase the density of magnetic lines, thereby enabling full utilization of the effective magnetic field of permanent magnet, increasing drive efficiency, and saving power consumption.

Another object of the present invention is to provide an auto-focusing device for lens, which is able to increase magnetic flux density, thereby allowing volume reduction.

Yet another object of the present invention is to provide an auto-focusing device for lens, which, by altering its assembly configuration, provides a good suspension cushion for lens holder, and at the same time, greatly simplifies the assembly process of device and cuts cost.

To achieve the aforesaid objects, the auto-focusing device for lens in one embodiment of the invention comprises a lens holder, a sensor holder, a permanent magnet set, a yoke and a base. The lens holder holds a lens barrel and is wound around with at least two coils in opposite directions. The sensor holder holds an image sensor. The permanent magnet set includes at least two permanent magnets stacked together with opposing poles to form a multi-pole permanent magnet set. The permanent magnet set is furnished on the periphery of lens holder and corresponding to the two coils. The permanent magnet set is disposed on the yoke to form a close-loop magnetism so as to increase the density of magnetic lines and the efficiency of magnetic force, and save power consumption.

In addition, the present invention provides a shock-absorbing mechanism with cushioning effect to accommodate and offer suspension support to the movable lens holder. The shock-absorbing mechanism includes a cover, a first spring, a second spring and a base. The cover and the base are configured respectively at the top and bottom of lens holder and securely adjoin to the base of auto-focusing device. The first spring is disposed between the lens holder and the cover, while the second spring is disposed between the lens holder and the base. The first spring and the second spring of the shock-absorbing mechanism have flat spring plate design. In contrast to other types of spring, the spring design in the present invention allows significant volume reduction and simplified assembly process of the auto-focusing device so as to lower the production cost.

### BRIEF DESCRIPTION OF THE DRAWINGS

The details of the present invention will be more readily understood from a detailed description of the preferred embodiments taken in conjunction with the following figures.

FIG. 1 is a diagram showing the focusing principle of conventional lens.

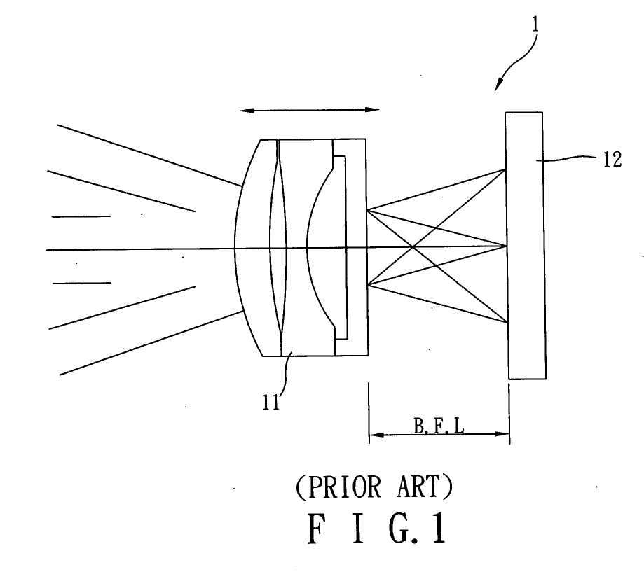

FIG. 2 is an exploded view of conventional zoom lens.

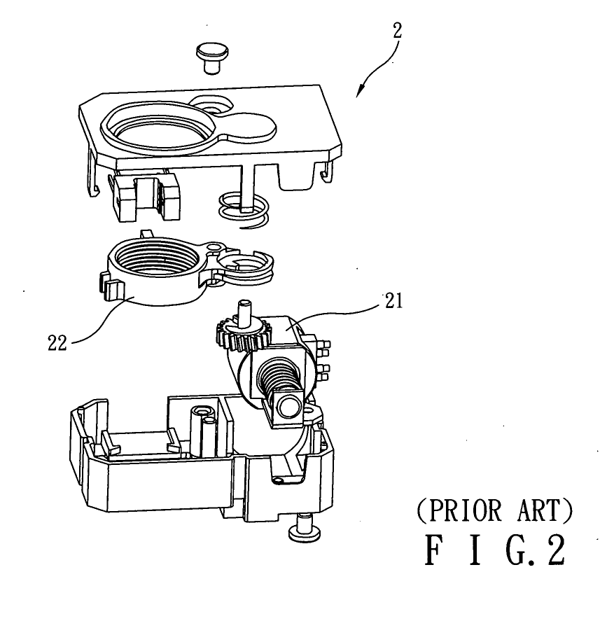

FIG. 3 is an exploded view of a preferred embodiment of auto-focusing device for lens according to the invention.

FIG. 4 is a schematic diagram of the lens holder of the auto-focusing device with coils wound around it according to the invention.

FIG. 5 is a diagram showing the magnetic action of auto-focusing device according to the invention.

FIG. 6 is an external view of the flat spring plate according to the invention.

### DETAILED DESCRIPTION

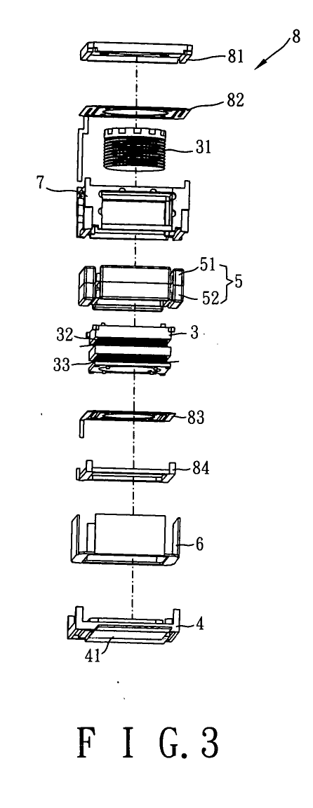

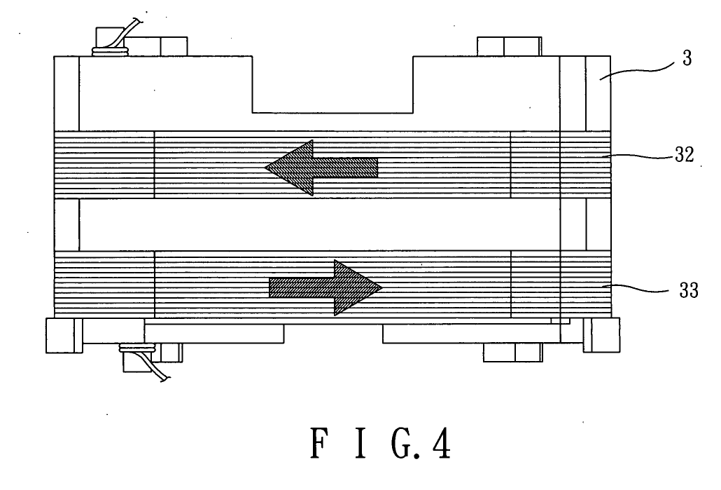

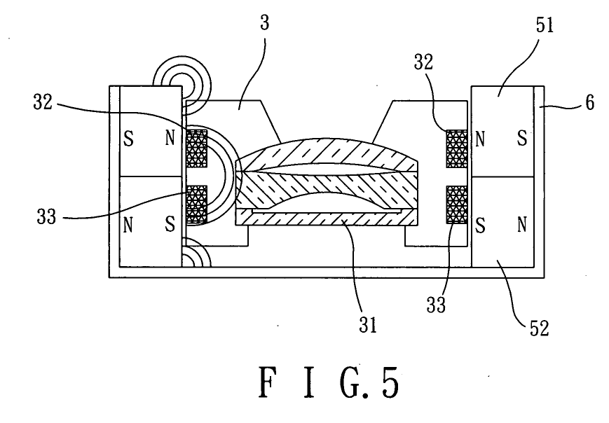

FIGS. 3, 4 and 5 show a preferred embodiment of the auto-focusing device for lens according to the present invention. FIG. 3 is an exploded view of the auto-focusing device; FIG. 4 is a schematic diagram of the lens holder of the auto-focusing device with coils wound around it; FIG. 5 is a diagram showing the magnetic action of the auto-focusing device.

As shown in FIG. 3, the auto-focusing device for lens in this embodiment comprises a lens holder 3, a sensor holder 4, magnets 5, a yoke 6, and a base 7. The lens holder 3 has a lens barrel 31 attached thereon and at least a first coils 32 and a second coils 33 wound on its periphery.

As shown in FIGS. 3 & 4, the adjacent first coils 32 and second coils 33 in this embodiment are wound in opposite directions. That is, when the first coils 32 and the second coils 33 are charged, their current directions are opposite to each other. The sensor holder 4 is attached with a CMOS/CCD sensor 41 thereon to receive the imaging light from lens barrel 31. The magnets 5 are made of at least a first magnet 51 and a second magnet 52 stacked together with opposing poles to form a multi-pole permanent magnet set 5. That is, the poles of the first magnet 51 and the second magnet 52 facing the lens barrel 31 are opposite to each other, rendering the upper half and lower half of the permanent magnet set 5 facing the lens barrel 31 to have opposing poles (as shown FIG. 5). The permanent magnet set 5 is disposed on the yoke 6 at the periphery of lens holder 3, and corresponds to the first coils 32 and second coils 33 located on lens holder 3. That is, the location of first magnet 51 essentially corresponds to that of first coils 32, and the location of second magnet 52 essentially corresponds to that of second coils 33.

When lens barrel 31 is about to shift position, a predetermined current is passed through the first coils 32 and the second coils 33 disposed on lens holder 3, causing the two coils 32, 33 to generate magnetic lines in specific directions. As a result, the magnetic action between first magnet 51 and second magnet 52 furnishes the force to push the lens holder 3 forward (as shown in the upper portion of FIG. 5) or backward (as shown in the lower portion of FIG. 5) along the axis of lens barrel 31. As such, the lens holder 3 holding the lens barrel 31 moves towards a predetermined direction to change the distance between lens barrel 31 and sensor 41 so as to achieve the purpose of focusing and zooming.

Referring to FIG. 5, through the structure described above, the first magnet 51 and the second magnet 52 of magnets 5 configured on yoke 6 can form a close-loop magnetism with the yoke 6 to increase the density of magnetic lines and improve the efficiency of magnetic force. Therefore in comparison to conventional devices, the present invention requires lower current to generate sufficient force to push the lens holder 3 and causes it to shift. It not only saves considerable power consumption, but also effectively prolongs the standby or operating time of product under the same battery capacity, hence providing more convenience to users.

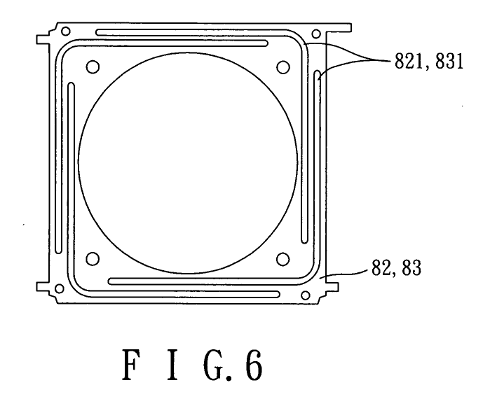

Again referring to FIG. 3, the lens holder 3 of the present invention further contains a shock-absorbing mechanism 8. The shock-absorbing mechanism 8 includes a cover 81, a first spring 82, a second spring 83 and a base 84. The cover 81 and the base 84 are configured respectively at the top and bottom of lens holder 3 and securely adjoin to the base 7 of auto-focusing device. The first spring 82 is disposed between lens holder 3 and cover 81, while the second spring 83 is disposed between lens holder 3 and base 84. The first spring 82 and the second spring 83 of the shock-absorbing mechanism 8 configured respectively anterior and posterior to lens holder 3 provides adequate suspension and supporting force to suspend lens holder 3 therein. When the lens holder 3 engages in anterior or posterior displacement, or when lens holder 3 is under the impact of external force while staying at a fixed location, both the first spring 82 and second spring 83 in the shock-absorbing mechanism 8 provides a cushion to absorb the impact. The first spring 82 and second spring 83 are flat spring plate. Referring to FIG. 6 which shows an external view of the flat spring plate, such spring plate features the arrangement of a plurality of long, hollowed-out slots 821, 831 on a flat piece with only a portion left for connection, where the restoring force of the spring provides the force needed for suspending and supporting lens holder 3. Even with other types of spring or spring plate, the present invention is able to reduce its overall volume, which represents excellent progress and contribution to miniaturization and enables it to be used by more products (e.g. notebook computer with built-in digital camera) to provide better focusing function.

Through the structural design just described, the present invention also offers the advantage of simplified assembly process in addition of volume reduction, hence helping to lower the manufacturing cost.

The description above presents only a preferred embodiment of the present invention. In fact, the present invention can similarly offer the advantages of increasing the density of magnetic lines and the efficiency of magnetic force by arranging the permanent magnetic set on a movable lens holder and disposing the first coils and second coils on the base of device.

What is claimed is:

1. An auto-focusing device for lens, comprising:
a lens holder attached with a lens barrel thereon and having at least two drive coils wound around its periphery with the adjacent coils wound in opposite directions; and
a permanent magnet set including at least two permanent magnets having opposite poles and stacked together; the permanent magnet set is arranged on the periphery of lens holder and its two permanent magnets essentially correspond to the two coils;
wherein by passing current through at least two drive coils, predetermined magnetic force is generated to push the lens holder together with the lens barrel thereon to displace.

2. The auto-focusing device for lens according to claim 1, wherein said permanent magnet set contains at least a first permanent magnet and a second permanent magnet stacked together with opposing poles such that the poles of first permanent magnet and the second permanent magnet facing the lens barrel are opposite to each other, rendering the upper half and the lower half of said permanent magnet set facing the lens barrel to have opposing poles.

3. The auto-focusing device for lens according to claim 1, further comprising:
a sensor holder having a sensor attached thereon for receiving the imaging light from the lens barrel; and
a base formed with an opening thereon to accommodate the lens holder and allowing the assembly of permanent magnet set and sensor holder to be secured thereon.

4. The auto-focusing device for lens according to claim 3, further comprising:
a yoke secured to the base and able to accommodate said permanent magnet set thereon to form a close-loop magnetism.

5. The auto-focusing device for lens according to claim 3, wherein said lens barrel is further arranged with a shock-absorbing mechanism therein to provide cushioning effect.

6. The auto-focusing device for lens according to claim 5, wherein said shock-absorbing mechanism includes a cover, a first spring, a second spring and a base, the cover and the base configured respectively at the top and bottom of lens holder and securely adjoining to the base of auto-focusing device, the first spring disposed between the lens holder and the cover, and the second spring disposed between the lens holder and the base of shock-absorbing mechanism.

7. The auto-focusing device for lens according to claim 6, wherein said first spring and said second spring are spring plates.

8. The auto-focusing device for lens according to claim 6, wherein by passing a predetermined current through the coils disposed on lens holder, the lens holder is able to carry out linear displacement in a predetermined direction.

9. An auto-focusing device for lens, comprising:
a lens holder attached with a lens barrel thereon and having drive coils wound around its periphery;
a sensor holder attached with a sensor thereon;
a permanent magnet set configured on the periphery of lens holder and corresponding to the coils disposed on lens holder;
a base formed with an opening thereon to accommodate the lens holder and allowing the assembly of permanent magnet set and sensor holder to be secured thereon; and
a shock-absorbing mechanism including a cover, a first spring, a second spring and a base, the cover and the base configured respectively at the top and bottom of lens holder and securely adjoining to the base of auto-focusing device, the first spring disposed between the lens holder and the cover, and the second spring disposed between the lens holder and the base of shock-absorbing mechanism.

10. The auto-focusing device for lens according to claim 9, further comprising:
a yoke secured to the base and able to accommodate said permanent magnet set thereon to form a close-loop magnetism.

11. The auto-focusing device for lens according to claim 9, wherein periphery of the lens holder is wound around with at least two drive coils.

12. The auto-focusing device for lens according to claim 11, wherein adjacent coils are wound in opposite directions.

13. The auto-focusing device for lens according to claim 9, wherein the permanent magnet set includes at least two permanent magnets stacked together.

14. The auto-focusing device for lens according to claim 13, wherein the permanent magnet set includes at least a first permanent magnet and a second permanent magnet stacked together with opposing poles such that the poles of first permanent magnet and the second permanent magnet facing the lens barrel are opposite to each other, rendering the upper half and the lower half of said permanent magnet set facing the lens barrel to have opposing poles.

15. The auto-focusing device for lens according to claim 9, wherein by passing current through the drive coils, predetermined magnetic force is generated to push the lens holder together with the lens barrel thereon to displace.

16. The auto-focusing device for lens according to claim 9, wherein said first spring and said second spring are spring plates.

17. The auto-focusing device for lens according to claim 16, wherein said spring plates are flat spring plates.
